(19) United States
(12) Patent Application Publication
(10) Pub. No.: US 2024/0419738 A1
(43) Pub. Date: Dec. 19, 2024

(54) SYSTEMS AND METHODS FOR GENERATING AND EXPANDING A TAXONOMY

(71) Applicant: RELX Inc., Miamisburg, OH (US)

(72) Inventors: Sanjay Sharma, Raleigh, NC (US); Mark Shewhart, Raleigh, NC (US)

(73) Assignee: RELX Inc., Miamisburg, OH (US)

(21) Appl. No.: 18/743,270

(22) Filed: Jun. 14, 2024

Related U.S. Application Data
(60) Provisional application No. 63/508,680, filed on Jun. 16, 2023.

(51) Int. Cl. G06F 16/906; G06F 16/901; G06F 16/93

(52) U.S. Cl. CPC G06F 16/906; G06F 16/9027; G06F 16/93

(57) ABSTRACT

A method for expanding a hierarchical taxonomy associated with a corpus of documents may include performing cluster analysis on documents associated with a leaf node of the taxonomy to determine a plurality of first clusters, each cluster of the plurality of first clusters being associated with one or more documents associated with the leaf node; determining one or more topics associated with the documents in each cluster of the plurality of first clusters; performing cluster analysis on the topics to determine a plurality of second clusters, each cluster of the plurality of second clusters being associated with one or more of the topics; determining a name for each cluster of the plurality of second clusters; and expanding the hierarchical taxonomy based on the topics associated with the documents in each cluster of the plurality of first clusters and the determined name for each cluster of the plurality of second clusters.

### CROSS-REFERENCE TO RELATED APPLICATION

This application claims priority to U.S. Provisional Application No. 63/508,680, filed Jun. 16, 2023, the entire contents of which is hereby incorporated by reference.

### FIELD

The present disclosure generally relates to document taxonomies, and more particularly, to systems and methods for generating and expanding a taxonomy.

### BACKGROUND

Searchable databases of documents are often arranged based on a taxonomy such that the database can be more easily searched. In particular, a taxonomy may include a plurality of categories and sub-categories. Each document may be classified within a particular sub-category. For example, a legal corpus may include documents such as legal opinions, verdicts, settlements, briefs, pleadings, motions, dockets, and the like. To assist researchers in finding relevant documents, a hierarchical taxonomy may be developed. That is, a highest level of a taxonomy may include a plurality of broad categories, each category of the first level may include a second level of more specific sub-categories, each sub-category of the second level may include a third level of even more specific sub-categories, and so on.

However, many fields, such as the legal field or the medical field, are dynamic, and change over time. As such, the associated document corpus may change over time. As the document corpus changes, new topics may be formed, and other topics may fade. Accordingly, the hierarchical taxonomy should be revised over time to account for such changes. Furthermore, it may be desirable to create particularly granular taxonomies so that researchers can more quickly and efficiently perform their search. Accordingly, a need exists for systems and methods for generating and expanding a taxonomy.

### SUMMARY

In one embodiment, a method may expand a hierarchical taxonomy associated with a corpus of documents. The hierarchical taxonomy may include a plurality of levels with each level comprising one or more nodes. The method may include performing cluster analysis on documents associated with a leaf node of the hierarchical taxonomy to determine a plurality of first clusters, each cluster of the plurality of first clusters being associated with one or more documents associated with the leaf node; determining one or more topics associated with the documents in each cluster of the plurality of first clusters; performing cluster analysis on the topics to determine a plurality of second clusters, each cluster of the plurality of second clusters being associated with one or more of the topics; determining a name for each cluster of the plurality of second clusters; and expanding the hierarchical taxonomy based on the topics associated with the documents in each cluster of the plurality of first clusters and the determined name for each cluster of the plurality of second clusters.

In another embodiment, a system may expand a hierarchical taxonomy associated with a corpus of documents. The hierarchical taxonomy may include a plurality of levels with each level comprising one or more nodes. The system may include a processing device and a non-transitory, processor-readable storage medium comprising one or more programming instructions stored thereon. When executed, the instructions may cause the processing device to perform cluster analysis on documents associated with a leaf node of the hierarchical taxonomy to determine a plurality of first clusters, each cluster of the plurality of first clusters being associated with one or more documents associated with the leaf node; determine one or more topics associated with the documents in each cluster of the plurality of first clusters; perform cluster analysis on the topics to determine a plurality of second clusters, each cluster of the plurality of second clusters being associated with one or more of the topics; determine a name for each cluster of the plurality of second clusters; and expand the hierarchical taxonomy based on the topics associated with the documents in each cluster of the plurality of first clusters and the determined name for each cluster of the plurality of second clusters.

In another embodiment, a non-transitory, computer-readable storage medium that is operable to perform a search of a corpus of documents may include one or more programming instructions stored thereon. The one or more programming instructions may cause the processing device to perform cluster analysis on documents associated with a leaf node of the hierarchical taxonomy to determine a plurality of first clusters, each cluster of the plurality of first clusters being associated with one or more documents associated with the leaf node; determine one or more topics associated with the documents in each cluster of the plurality of first clusters; perform cluster analysis on the topics to determine a plurality of second clusters, each cluster of the plurality of second clusters being associated with one or more of the topics; determine a name for each cluster of the plurality of second clusters; and expand the hierarchical taxonomy based on the topics associated with the documents in each cluster of the plurality of first clusters and the determined name for each cluster of the plurality of second clusters.

These and other features, and characteristics of the present technology, as well as the methods of operation and functions of the related elements of structure and the combination of parts and economics of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

FIG. 1 schematically depicts an illustrative computing network for a system for generating and expanding a taxonomy according to one or more embodiments shown and described herein;

FIG. 2 schematically depicts the server computing device from FIG. 1, further illustrating hardware and software that may be used in generating and expanding a taxonomy according to one or more embodiments shown and described herein; and

FIG. 3 depicts a flow diagram of an illustrative method of generating and expanding a taxonomy according to one or more embodiments shown and described herein.

### DETAILED DESCRIPTION

Referring generally to the figures, embodiments described herein are directed to systems and methods for generating and expanding a taxonomy. In embodiments, a leaf node of a taxonomy may be selected. A plurality of documents associated with the leaf node may be selected and clustered. The documents associated with one or more of the clusters may be submitted to a large language model, which is asked to identify topics associated with each cluster. Each of the identified topics may then be clustered using a clustering algorithm. The topics associated with each cluster may be submitted to the large language model, which is asked to identify categories associated with the topics for each cluster. Accordingly, an additional two levels may be added to the hierarchical taxonomy.

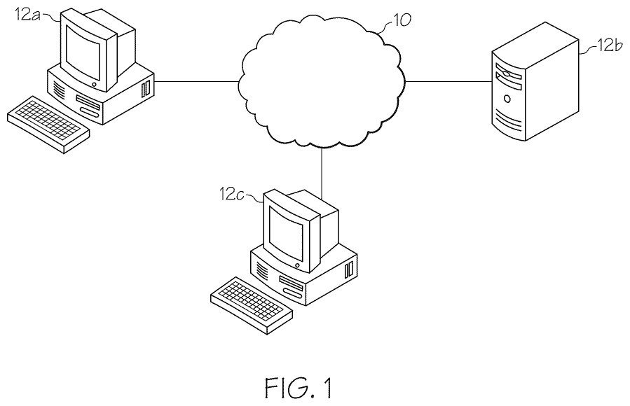

Referring now to the drawings, FIG. 1 depicts an illustrative computing network, illustrating components of a system for performing the functions described herein, according to embodiments shown and described herein. As illustrated in FIG. 1, a computer network 10 may include a wide area network, such as the internet, a local area network (LAN), a mobile communications network, a public service telephone network (PSTN) and/or other network and may be configured to electronically connect a user computing device 12a, a server computing device 12b, and an administrator computing device 12c.

The user computing device 12a may be used to input information from a user and display information to the user. The user computing device 12a may also be utilized to perform other user functions.

The administrator computing device 12c may, among other things, perform administrative functions for the server computing device 12b. In the event that the server computing device 12b requires oversight, updating, or correction, the administrator computing device 12c may be configured to provide the desired oversight, updating, and/or correction. The administrator computing device 12c, as well as any other computing device coupled to the computer network 10, may be used to input one or more documents into the document database.

The server computing device 12b may receive instructions from the user computing device 12a to expand a taxonomy. The server computing device 12b may also transmit information about the expanded taxonomy to the user computing device 12a. The components and functionality of the server computing device 12b will be set forth in detail below.

It should be understood that while the user computing device 12a and the administrator computing device 12c are depicted as personal computers and the server computing device 12b is depicted as a server, these are non-limiting examples. More specifically, in some embodiments any type of computing device (e.g., mobile computing device, personal computer, server, etc.) may be utilized for any of these components. Additionally, while each of these computing devices is illustrated in FIG. 1 as a single piece of hardware, this is also merely an example. More specifically, each of the user computing device 12a, the server computing device 12b, and the administrator computing device 12c may represent a plurality of computers, servers, databases, etc.

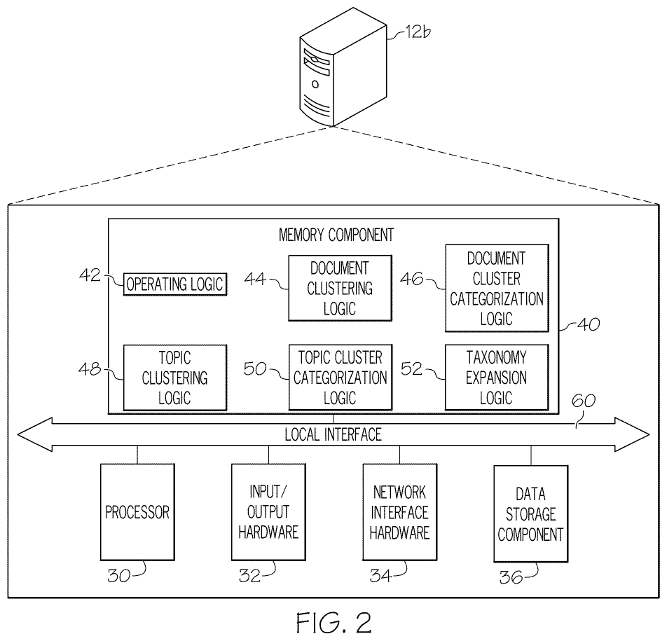

FIG. 2 depicts additional details regarding the server computing device 12b from FIG. 1. While in some embodiments, the server computing device 12b may be configured as a general purpose computer with the requisite hardware, software, and/or firmware, in some embodiments, that server computing device 12b may be configured as a special purpose computer designed specifically for performing the functionality described herein.

As also illustrated in FIG. 2, the server computing device 12b may include a processor 30, input/output hardware 32, network interface hardware 34, a data storage component 36, and a non-transitory memory component 40. The memory component 40 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components. Additionally, the memory component 40 may be configured to store operating logic 42, document clustering logic 44, document cluster categorization logic 46, topic clustering logic 48, topic cluster categorization logic 50, and taxonomy expansion logic 52 (each of which may be embodied as a computer program, firmware, or hardware, as an example). A local interface 60 is also included in FIG. 2 and may be implemented as a bus or other interface to facilitate communication among the components of the server computing device 12b.

The processor 30 may include any processing component configured to receive and execute instructions (such as from the data storage component 36 and/or memory component 40). The input/output hardware 32 may include a monitor, keyboard, mouse, printer, camera, microphone, speaker, touch-screen, and/or other device for receiving, sending, and/or presenting data. The network interface hardware 34 may include any wired or wireless networking hardware, such as a modem, LAN port, wireless fidelity (Wi-Fi) card, WiMax card, mobile communications hardware, and/or other hardware for communicating with other networks and/or devices.

It should be understood that the data storage component 36 may reside local to and/or remote from the server computing device 12b and may be configured to store one or more pieces of data for access by the server computing device 12b and/or other components (e.g., data associated with a taxonomy, and model parameters, as discussed below). Other data may be stored in the data storage component 36 to provide support for functionalities described herein.

Included in the memory component 40 are the operating logic 42, the document clustering logic 44, the document cluster categorization logic 46, the topic clustering logic 48, the topic cluster categorization logic 50, and the taxonomy expansion logic 52. The operating logic 42 may include an operating system and/or other software for managing components of the server computing device 12b. The functionalities of the document clustering logic 44, the document cluster categorization logic 46, the topic clustering logic 48, the topic cluster categorization logic 50, and the taxonomy expansion logic 52 will be described in further detail below.

It should be understood that the components illustrated in FIG. 2 are merely illustrative and are not intended to limit the scope of this disclosure. More specifically, while the components in FIG. 2 are illustrated as residing within the server computing device 12b, this is a non-limiting example. In some embodiments, one or more of the components may reside external to the server computing device 12b. Similarly, while FIG. 2 is directed to the server computing device 12b, other components such as the user computing device 12a and the administrator computing device 12c may include similar hardware, software, and/or firmware.

The document clustering logic 44 may use a clustering algorithm to perform clustering of a plurality of documents associated with a node or sub-category of a taxonomy associated with a document corpus, as disclosed herein. As discussed above, a document corpus may have an associated taxonomy that categorizes each document in the corpus to improve case of searching the corpus. In particular, a hierarchical taxonomy may include a first level with a plurality of nodes comprising broad categories, each node at this level may be associated with one or more second level nodes representing subcategories, each second level node may be associated with one or more third level nodes representing more specific subcategories, and so on. The lowest level may include nodes having the most narrow sub-categories. The lowest level nodes may be referred to as leaf nodes.

For example, in a legal document taxonomy, a leaf node of “Statutory Awards” may be arranged as follows: Civil Procedure>Remedies>Costs & Attorney Fees>Attorney Fees & Expenses>Basis of Recovery>Statutory Awards. That is, The first level category may be “Civil Procedure”, the second level sub-category may be “Remedies”, the third level sub-category may be “Costs & Attorney Fees”, the fourth level sub-category may be “Attorney Fees & Expenses”, the fifth level sub-category may “Basis of Recovery”, and the sixth level or leaf node may be “Statutory Awards”.

The “Statutory Awards” node may include one or more documents associated with that subcategory. As discussed above, it may be desirable to add additional, more specific nodes, below the “Statutory Awards” node. The documents associated with the “Statutory Awards” node may then be split up across the additional nodes to improve case of search. This may be accomplished using the techniques disclosed herein.

In embodiments, the document clustering logic 44 may utilize a clustering algorithm to put each of the documents in “Statutory Awards” sub-category into one of a plurality of clusters. In one example, the document clustering logic 44 may utilize natural language processing techniques to determine a vectorization of each of the documents in the “Statutory Awards” sub-category. In one example, the document clustering logic 44 may perform natural language processing on the entire text of each document to determine a vectorization of each such document. In other examples, the document clustering logic 44 may perform natural language processing on only a portion of each document (e.g., the abstract) to determine a vectorization of that portion of each such document.

After determining a vectorization of each document of the “Statutory Awards” sub-category, the document clustering logic 44 may utilize a clustering algorithm to identify a plurality of clusters based on the vectorizations of the documents. The document clustering logic 44 may then associate each document in the sub-category with one of the identified clusters. The document clustering logic 44 may use any type of clustering algorithm (e.g., K-means, Gaussian Mixture Model, etc.). In some examples, the document clustering logic 44 may associate each document with a cluster based on a similarity between the vectorizations of the documents (e.g., based on cosine similarity). After the document clustering logic 44 performs the cluster analysis, a plurality of clusters may be identified and each document under the “Statutory Awards” node may be associated with one of the clusters.

In one example, the document clustering logic 44 may identify six clusters of documents associated with the “Statutory Awards” node. However, in other examples, the document clustering logic 44 may identify any number of clusters. Furthermore, while the above example describes performing clustering on the “Statutory Awards” node, it should be understood that the document clustering logic 44 may performing cluster analysis for any leaf node of a hierarchical taxonomy.

Referring still to FIG. 2, the document cluster categorization logic 46 may determine a category or topic associated with each of the clusters identified by the document clustering logic 44, as disclosed herein. In particular, the document cluster categorization logic 46 may input the documents associated with each cluster into a large language model (“LLM”), along with a prompt asking the LLM to suggest topics based on the documents for each cluster.

An LLM is a machine learning model that receives a natural language prompt and outputs text in response to the prompt. LLMs are typically trained on a large set of natural language data, such that after they are trained, they may output responses to prompts. Examples of LLMS include GPT3, ChatGPT, and Gemini. In some examples, LLMs may also receive documents or other inputs along with a natural language prompt. For example, an LLM may be asked to analyze and provide a summary of a paper.

In embodiments, the document cluster categorization logic 46 may submit a prompt to a trained LLM asking for a category or topic that categorizes the documents of a cluster. For example, a prompt of “what topic categorizes these documents?” may be submitted to an LLM along with the documents of a cluster. In some examples, the full text of the documents of the cluster may be submitted to the LLM along with the prompt. In some examples, only a portion of the documents of the cluster may be submitted to the LLM (e.g., the abstract) along with the prompt. In some examples, the vectorization of the documents or portions thereof may be submitted to the LLM along with the prompt.

In response to the input prompt, the LLM may generate one or more topics that categorize the documents of the cluster. In some examples, a single topic may be generated. In other examples, multiple topics may be generated. In one example, the LLM may output the following suggested topics for a first cluster of the “Statutory Awards” node:
Equal Access to Justice Act (EAJA) Awards;
Maximum Hourly Rate;
Calculation of Hourly Rate;
Factors Considered in Determining Reasonableness of Attorney's Fees;
Reimbursement Limits”; and
Consumer Price Index (CPI) and Hourly Rate.

The document cluster categorization logic 46 may input the same or similar prompt into the trained LLM along with the documents associated with each cluster. In the example discussed above, where the document clustering logic 44 identified six clusters, the document cluster categorization logic 46 may ask the LLM to generate topics for each of the six clusters. In one example, the LLM may output the following suggested topics for a second cluster of the “Statutory Awards” node:
Federal law authorizations;
State law authorizations;
Lodestar method of fee calculation;
Reasonable hourly rate;
Community rate comparison;
Court's discretion in fee award
Burden of proof for fee award;
Contemporaneous time records requirement;
Exception to general rule of paying own attorney's fees;
Statutes authorizing fee awards;
Factors for awarding attorney's fees;
Standard of review for fee awards;
Availability of fee-shifting provisions;
Exception to attorney fees not allowed for prevailing party;
Statutes authorizing reimbursement of attorney fees; and
Availability of attorney fees in specific circumstances (e.g., in appeals, arising from contract, in property tax matters, under IDEA).

In one example, the LLM may output the following suggested topics for a third cluster of the “Statutory Awards” node:
Basis of Recovery for Attorney's Fees in Contract Cases (based on Civ. Code, § 1717;
Requirements for Recovery of Attorney's Fees under Tex. Civ. Prac. & Rem. Code Ann. ch. 39 (based on Tex. Civ. Prac. & Rem. Code Ann. § 38.001;
Standard of Review for Court's Award of Attorney's Fees under Code Civ. Proc., § 1021.5 (based on deferential abuse of discretion standard of review);
Factors Considered for Attorney Fees under Code Civ. Proc., § 1021.5 (based on the private attorney general doctrine);
Eligibility Criteria for Attorney Fees under Code Civ. Prlc., § 1021.5 (based on enforcement of an important right affecting the public interest, conferring significant benefit, and the necessity and financial burden of private enforcement);
Basis of Recovery for Attorney's Fees in Parent-Child Relationship Cases (based on Tex. Fam. Code Ann. § 106.002(a));
Requirements for Recovery of Attorney's Fees in Parent-Child Relationship Cases (based on the discretion of trial court);
Requirements for Recovery of Attorney's Fees in General (based on Tex. Civ. Prac. & Rem. Code Ann. §§ 38.001, 0.002).
Basis of Recovery for Attorney's Fees in Oral or Written Contract Cases (based on Tex. Civ. Prac. & Rem. Code Ann. § 38.001(8)); and
Basis of Recovery for Attorney's Fees in Derivative Actions (based on Idaho Code Ann. § 30-25-806).

In one example, the LLM may output the following suggested topics for a fourth cluster of the “Statutory Awards” node:
Awards under Code Civ. Proc., § 1021.5;
Awards under Colo. Rev. Stat. § 13-17-102;
Awards under Ariz. Rev. Stat. § 12-348(B)(1);
Awards under N.C. Gen Stat. § 50-13.6;
Awards under O.C.G.A. § Sep. 11, 1968;
Awards under Colo. Rev. Stat. § Oct. 3, 1116;
Awards as Costs or Damages; and
AWARDS UNDER O.C.G.A § 13-6-11.

In one example, the LLM may output the following suggested topics for a fifth cluster of the “Statutory Awards” node:
Requirements for recovery of attorney fees and costs;
Calculation of attorney fees and costs;
Reasonable basis for petition;
Good faith requirement;
Prevailing market rate;
Burden of proof;
Entitlement to interim fees and costs;
Reasonableness of hours expended;
Special master discretion;
Award for successful petitions;
Court of Federal Claims jurisdiction; and
Reimbursable tasks and activites.

In one example, the LLM may output the following suggested topics for a sixth cluster of the “Statutory Awards” node:
Equal Access to Justice Act (EAJA) Awards;
Fair Housing Act (FHA) Awards;
Mass. Gen. Laws ch. 149 Awards;
28 U.S.C.S. § 2412 Awards;
RSA 356-B:15 Awards;
ERISA Awards;
Interim Awards;
Postjudgment Awards; and
Reasonable Attorney Fees Awards.

Referring still to FIG. 2, the topic clustering logic 48 may perform cluster analysis on the topics output by the document cluster categorization logic 46, as disclosed herein. As discussed above, the document cluster categorization logic 46 may input documents associated with each of a plurality of clusters into an LLM along with a prompt, and the LLM may output suggested topics for each of the clusters. There may be duplicates and/or overlap within the topics generated by the document cluster categorization logic 46.

The topic clustering logic 48 performs cluster analysis on all of the topics generated by the document cluster categorization logic 46. The topic clustering logic 48 may utilize a variety of clustering algorithms to perform the cluster analysis (e.g., K-means, Gaussian Mixture Model, etc.). In some examples, the topic clustering logic 48 may use natural language processing techniques to determine a vectorization of each of the topics, and the topic clustering logic 48 may perform cluster analysis based on the determined vectorizations. For example, the topic clustering logic 48 may group topics into a cluster if their vectorizations are within a threshold similarity of each other (e.g., based on cosine similarity). As such, the topic clustering logic 48 may identify one or more clusters of topics, with each cluster including one or more topics.

Referring still to FIG. 2, the topic cluster categorization logic 50 may determine a category for each of the clusters determined by the topic clustering logic 48, as disclosed herein. In particular, for each cluster of topics identified by the document cluster categorization logic 46, the topic cluster categorization logic 50 may input the topics into a trained LLM, along with a prompt asking the LLM to determine a name or category for the for the topics in the cluster. In some examples, the LLM used by the topic cluster categorization logic 50 is the same LLM used by the document cluster categorization logic 46. In other examples, the LLM used by the topic cluster categorization logic 50 is different than the LLM used by the document cluster categorization logic 46. In some examples, the topic cluster categorization logic 50 may submit the vectorizations of the topics rather than the topic names to the LLM.

After the LLM receives the topics of a cluster and the prompt, the LLM may respond to the prompt by generating a name or category for the topics of the cluster. As such, each of the topics generated by the document cluster categorization logic 46 may be assigned to a named cluster. Therefore, two additional node levels may be added to the taxonomy. The topic cluster names generated by the topic cluster categorization logic 50 may be added as additional nodes below a leaf node of the current taxonomy. The topics within each cluster as determined by the topic clustering logic 48, may be added as nodes below the associated topic cluster names.

In the example regarding the “Statutory Awards” leaf node, and the example topics from the six nodes discussed above, the topic cluster categorization logic 50 may identify the following topic cluster names and associated topics within each cluster:

### Requirements for Recovery of Attorney Fees and Costs:

Fair Housing Act (FHA) Awards
Equal Access to Justice Act (EAJA) Awards.
Mass. Gen. Laws ch. 149 Awards.
28 U.S.C.S. § 2412 Awards
RSA 356-B:15 Awards
ERISA Awards
Eligibility Criteria for Attorney Fees under Code Civ. Proc., § 1021.5.
Requirements for Recovery of Attorney Fees in Parent-Child Relationship Cases.
Requirements for Recovery of Attorney Fees in General.
Requirements for Recovery of Attorney Fees under Tex. Civ. Prac. & Rem. Code Ann. ch. 38.
Basis of Recovery for Attorney's Fees in Contract Cases.
Basis of Recovery for Attorney's Fees in Oral or Written Contract Cases.
Basis of Recovery for Attorney's Fees in Derivative Actions
Awards under Ariz. Rev. Stat. § 12-348(B)(1)
Awards under Colo. Rev. Stat. § Oct. 3, 1116
Awards under Colo. Rev. Stat. § 13-17-102
Awards under N.C. Gen Stat. § 50-13.6
Awards under O.C.G.A. § Sep. 11, 1968
Awards under O.C.G.A. § 13-6-11

### Calculation of Attorney Fees and Costs:

Maximum Hourly Rate
Calculation of Hourly Rate
Lodestar method of fee calculation

### Reasonable Hourly Rate

Community rate comparison
Standard of review for fee awards
Reasonable Basis for Petition:
Availability of fee-shifting provisions
Exception to general rule of paying own attorney's fees
Exception to attorney fees not allowed for prevailing party
Statutes authorizing fee awards
Statutes authorizing reimbursement of attorney fees
Availability of attorney fees in specific circumstances (e.g., in appeals, arising from contract, in property tax matters, under IDEA)
Awards as Costs or Damages

### Good Faith Requirement:

Court's discretion in fee award
Burden of proof for fee award
Contemporaneous time records requirement

### Prevailing Market Rate:

Factors Considered in Determining Reasonableness of Attorney's Fees
Factors for awarding attorney's fees
Standard of review for fee awards.
Standard of Review for Court's Award of Attorney's Fees under Code Civ. Proc., § 1021.5
Factors Considered for Attorney Fees under Code Civ. Proc., § 1021.5
Eligibility Criteria for Attorney Fees under Code Civ. Proc., § 1021.5

### Burden of Proof:

Exception to general rule of paying own attorney's fees
Statutes authorizing fee awards
Statutes authorizing reimbursement of attorney fees
Availability of attorney fees in specific circumstances (e.g., in appeals, arising from contract, in property tax matters, under IDEA)
Availability of fee-shifting provisions

### Entitlement to Interim Fees and Costs:

Interim Awards
Postjudgment Awards

### Reasonableness of Hours Expended:

Reasonable Attorney Fees Awards
Contemporaneous time records requirement
Factors Considered in Determining Reasonableness of Attorney's Fees

### Special Master Discretion:

Court's discretion in fee award
Factors for awarding attorney's fees
Factors Considered for Attorney Fees under Code Civ. Proc., § 1021.5
Standard

Referring still to FIG. 2, the taxonomy expansion logic 52 may expand the taxonomy, as disclosed herein. As discussed above, the names of the topic clusters determined by the topic clustering logic 48 may be added as nodes below a leaf node of the taxonomy, and the topics within each of those clusters may be added as nodes below them. The documents associated with each cluster may be associated with the associated topics. Accordingly, the taxonomy expansion logic 52 may expand the taxonomy by two node levels.

In the example discussed above for the “Statutory Awards” leaf node, the bold category names “Requirements for Recovery of Attorney Fees and Costs”, “Calculation of Attorney Fees and Costs”, “Reasonable Basis for Petition”, “Good Faith Requirement”, “Prevailing Market Rate”, “Burden of Proof”, “Entitlement to Interim Fees and Costs”, “Reasonableness of Hours Expended”, and “Special Master Discretion” may be added as nodes below the “Statutory Awards” node. Each of the topics listed below the bold category names may be added as nodes below the associated category. The documents associated with each topic, as determined by the document clustering logic 44 and the document cluster categorization logic 46, may be associated with the corresponding topic nodes. As such, the expanded taxonomy may allow a user perform a more precise search using the expanded taxonomy with additional nodes.

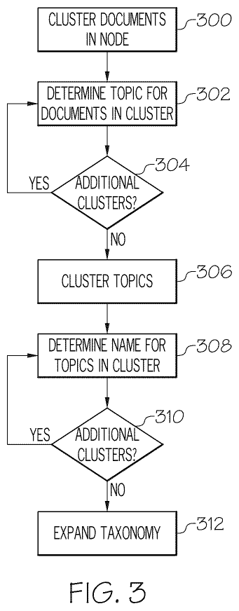

Turning now to FIG. 3, a flowchart is shown of an example method that may be performed by the server computing device 12b. Although the steps associated with the blocks of FIG. 3 will be described as being separate tasks, in other embodiments, the blocks may be combined or omitted. Further, while the steps associated with the blocks of FIG. 3 will be described as being performed in a particular order, in other embodiments, the steps may be performed in a different order.

At step 300, the document clustering logic 44 clusters documents in a leaf node of a taxonomy associated with a corpus of documents using a clustering algorithm. In some examples, a user may specify a leaf node that is to be expanded. In other examples, the server computing device 12b may expand each leaf node of a taxonomy, and the steps of the method of FIG. 3 may be repeatedly performed for each leaf node of the taxonomy. In embodiments, the document clustering logic 44 may determine a plurality of clusters for the documents in the leaf node, with each cluster including one or more of such documents. In some examples, the document clustering logic 44 may perform clustering based on vectorizations of the documents or a portion thereof.

At step 302, the document cluster categorization logic 46 determines one or more topics for the documents in one of the clusters determined by the document clustering logic 44. In particular, the document cluster categorization logic 46 may input the documents associated with the cluster into an LLM, along with a prompt asking for one or more topics associated with the documents in the cluster. The LLM may output one or more topics in response to the prompt.

At step 304, the document cluster categorization logic 46 determines whether there are additional clusters that have not been analyzed by the document cluster categorization logic 46. If there are additional clusters (Yes at step 304), then control returns to step 302, and the document cluster categorization logic 46 determines a topic for the documents in a different one of the clusters. If there are no additional clusters (No at step 304), then control passes to step 306.

At step 306, the topic clustering logic 48 clusters the topics determined by the document cluster categorization logic 46 using a clustering algorithm. In particular, the topic clustering logic 48 may determine one or more clusters of topics, with each cluster including one or more topics. The topic clustering logic 48 may perform clustering based on vectorizations of the topics.

At step 308, the topic cluster categorization logic 50 determines a name for the topics in one of the clusters determined by the topic clustering logic 48. In particular, the topic cluster categorization logic 50 may input the topics associated with the cluster into an LLM, along with a prompt asking for a name associated with the topics. The LLM may output a name for the topics of the cluster in response to the prompt.

At step 310, the topic cluster categorization logic 50 determines whether there are any additional clusters that have not been analyzed by the topic cluster categorization logic 50. If there are additional clusters (Yes at step 310), then control returns to step 308 and the topic cluster categorization logic 50 determines a name for the topics in another one of the clusters. If there are no additional clusters (No at step 310), then control passes to step 312.

At step 312, the taxonomy expansion logic 52 expands the taxonomy. In particular, the taxonomy expansion logic 52 adds each of the topic names determined by the topic cluster categorization logic 50 as nodes under the selected leaf node of the taxonomy. The taxonomy expansion logic 52 then adds each of the topics associated with each of the topic names as nodes under the respective topic names.

It should now be understood that embodiments disclosed herein are directed to systems and methods for generating and expanding a taxonomy. By using natural language processing, cluster analysis, and large language models, a taxonomy can automatically be expanded by two levels. This can provide a more granular and precise taxonomy, which may allow for researchers to more easily and accurately search the corpus associated with the taxonomy.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method for expanding a hierarchical taxonomy associated with a corpus of documents, the hierarchical taxonomy comprising a plurality of levels with each level comprising one or more nodes, the method comprising:
performing cluster analysis on documents associated with a leaf node of the hierarchical taxonomy to determine a plurality of first clusters, each cluster of the plurality of first clusters being associated with one or more documents associated with the leaf node;
determining one or more topics associated with the documents in each cluster of the plurality of first clusters;
performing cluster analysis on the topics to determine a plurality of second clusters, each cluster of the plurality of second clusters being associated with one or more of the topics;
determining a name for each cluster of the plurality of second clusters; and
expanding the hierarchical taxonomy based on the topics associated with the documents in each cluster of the plurality of first clusters and the determined name for each cluster of the plurality of second clusters.

2. The method of claim 1, wherein performing the cluster analysis on the documents associated with the leaf node of the hierarchical taxonomy comprises:
using natural language processing to determine vectorizations associated with the documents; and
performing cluster analysis of the vectorizations associated with the documents.

3. The method of claim 1, wherein performing the cluster analysis on the documents associated with the leaf node of the hierarchical taxonomy comprises:
using natural language processing to determine vectorizations of portions of each of the documents; and
performing cluster analysis of the vectorizations.

4. The method of claim 2, further comprising:
determining the plurality of first clusters based on a cosine similarity between the vectorizations associated with the documents.

5. The method of claim 1, wherein determining the one or more topics associated with the documents in each cluster of the plurality of first clusters comprises:
inputting the documents and a prompt into a large language model; and
determining the one or more topics based on an output of the large language model.

6. The method of claim 5, wherein the prompt asks the large language model to generate the one or more topics based on the documents.

7. The method of claim 1, wherein performing the cluster analysis on the topics comprises:
using natural language processing to determine vectorizations associated with the topics; and
performing cluster analysis on the vectorizations.

8. The method of claim 1, wherein determining the name for each cluster of the plurality of second clusters comprises:
inputting the topics for each cluster of the plurality of second clusters and a prompt into a large language model; and
determining the name for each cluster of the plurality of second clusters based on an output of the large language model.

9. The method of claim 8, wherein the prompt asks the large language model to generate the name for each cluster of the plurality of second clusters based on the topics for each cluster.

10. The method of claim 1, wherein expanding the hierarchical taxonomy comprises:
adding a plurality of first nodes below the leaf node comprising the determined name for each cluster of the plurality of second clusters; and
adding a plurality of second nodes below the first nodes comprising the determined topics associated with the documents in each cluster of the plurality of first clusters.

11. A system for expanding a hierarchical taxonomy associated with a corpus of documents, the hierarchical taxonomy comprising a plurality of levels with each level comprising one or more nodes, the system comprising:
a processing device; and
a non-transitory, processor-readable storage medium comprising one or more programming instructions stored thereon that, when executed, cause the processing device to:
perform cluster analysis on documents associated with a leaf node of the hierarchical taxonomy to determine a plurality of first clusters, each cluster of the plurality of first clusters being associated with one or more documents associated with the leaf node;
determine one or more topics associated with the documents in each cluster of the plurality of first clusters;
perform cluster analysis on the topics to determine a plurality of second clusters, each cluster of the plurality of second clusters being associated with one or more of the topics;
determine a name for each cluster of the plurality of second clusters; and
expand the hierarchical taxonomy based on the topics associated with the documents in each cluster of the plurality of first clusters and the determined name for each cluster of the plurality of second clusters.

12. The system of claim 11, wherein the instructions cause the processing device to:
use natural language processing to determine vectorizations associated with the documents; and
perform cluster analysis of the vectorizations associated with the documents.

13. The system of claim 12, wherein the instructions cause the processing device to:
determine the plurality of first clusters based on a cosine similarity between the vectorizations associated with the documents.

14. The system of claim 11, wherein the instructions cause the processing device to determine the one or more topics associated with the documents in each cluster of the plurality of first clusters by:
inputting the documents and a prompt into a large language model; and
determining the one or more topics based on an output of the large language model.

15. The system of claim 14, wherein the prompt asks the large language model to generate the one or more topics based on the documents.

16. The system of claim 11, wherein the instructions cause the processing device to perform the cluster analysis on the topics by:
using natural language processing to determine vectorizations associated with the topics; and
performing cluster analysis on the vectorizations.

17. The system of claim 11, wherein the instructions cause the processing device to determine the name for each cluster of the plurality of second clusters by:
inputting the topics for each cluster of the plurality of second clusters and a prompt into a large language model; and
determining the name for each cluster of the plurality of second clusters based on an output of the large language model.

18. The system of claim 17, wherein the prompt asks the large language model to generate the name for each cluster of the plurality of second clusters based on the topics for each cluster.

19. The system of claim 11, wherein the instructions cause the processing device to expand the hierarchical taxonomy by:
adding a plurality of first nodes below the leaf node comprising the determined name for each cluster of the plurality of second clusters; and
adding a plurality of second nodes below the first nodes comprising the determined topics associated with the documents in each cluster of the plurality of first clusters.

20. A non-transitory, computer-readable storage medium that is operable by a computer to expand a hierarchical taxonomy associated with a corpus of documents, the hierarchical taxonomy comprising a plurality of levels with each level comprising one or more nodes, the non-transitory, computer-readable medium comprising one or more programming instructions stored thereon for causing a processing device to:
perform cluster analysis on documents associated with a leaf node of the hierarchical taxonomy to determine a plurality of first clusters, each cluster of the plurality of first clusters being associated with one or more documents associated with the leaf node;
determine one or more topics associated with the documents in each cluster of the plurality of first clusters;
perform cluster analysis on the topics to determine a plurality of second clusters, each cluster of the plurality of second clusters being associated with one or more of the topics;
determine a name for each cluster of the plurality of second clusters; and
expand the hierarchical taxonomy based on the topics associated with the documents in each cluster of the plurality of first clusters and the determined name for each cluster of the plurality of second clusters.
